(19) United States
(12) Patent Application Publication
(10) Pub. No.: US 2024/0194362 A1
(43) Pub. Date: Jun. 13, 2024

(54) REFUELLING A NUCLEAR REACTOR

(71) Applicant: Rolls-Royce SMR Limited, Derby, Derbyshire (GB)

(72) Inventor: Daniel ROBERTSON, Derby, Derbyshire (GB)

(21) Appl. No.: 18/554,424

(22) PCT Filed: Apr. 14, 2022
(86) PCT No.: PCT/EP2022/060105

§ 371 Date: Oct. 6, 2023

(30) Foreign Application Priority Data
Apr. 19, 2021 (GB) 2105562.9

(51) Int. Cl. G21C 19/20; G21C 11/00; G21C 19/32

(52) U.S. Cl. CPC G21C 19/20; G21C 11/00; G21C 19/32

(57) ABSTRACT

A lift head for a reactor pressure vessel comprising a lift head which can be coupled and removed to a reactor pressure vessel head, and radiation shielding. The radiation shielding is connectable to the lift head such that the lift head and the radiation shield encase the reactor pressure vessel head and any head package contents removed from a reactor pressure vessel with the reactor pressure vessel head. The radiation shield may be of a clam shell construction. The lift head may be provided with a mechanism for fastening and unfastening the bolts connecting the reactor pressure vessel head to the reactor pressure vessel. The lift head may be provided with monitoring equipment to monitor the core internals.

This application claims priority from GB 2105562.9 filed 19 Apr. 2021, the contents and elements of which are herein incorporated by reference for all purposes.

### FIELD OF THE DISCLOSURE

The present disclosure relates to refuelling a nuclear reactor. In particular, it relates to a device and a method for lifting the head of a nuclear reactor to allow for refuelling.

### BACKGROUND OF THE DISCLOSURE

Nuclear power plants convert heat energy from the nuclear fission of fissile material contained in fuel assemblies into electrical energy. Pressurised water reactor (PWR) nuclear power plants have a primary coolant circuit which typically connects the following pressurised components: a reactor pressure vessel (RPV) containing the fuel assemblies; one or more steam generators; and a pressuriser. Coolant pumps in the primary circuit circulate pressurised water through pipework between these components. The RPV houses the nuclear core which heats the water in the primary circuit. The steam generator functions as a heat exchanger between the primary circuit and a secondary system where steam is generated to power turbines. Boiling Water Reactors (BWR) operate in a similar way to a PWR except that rather than using high pressure circuits to maintain the water in its liquid states, BWRs use the core to heat the water to turn it into steam to drive the steam generators.

Such reactors require refuelling at intervals of typically 18-24 months. During this refuelling the reactor is powered down and the head of the reactor pressure vessel is removed. The PWR or BWR plant will be depressurised to equalise pressure to that of the atmosphere within the containment building, and where necessary the water in the primary loop will be drained to a level just below that of the head of the reactor. FIG. 1 presents an example of a prior art reactor with associated refuelling equipment 10. In this the reactor uses a water filed refuelling cavity 11, with the head of the reactor pressure vessel 13 sitting in the cavity and designed to hold a volume of water. The reactor is housed within a containment structure having walls 12. In order to allow for refuelling the head of the reactor is unbolted and lifted to another location (not shown), which does not interfere with refuelling operations. The cavity above the reactor head is filed with water of the same quality as the primary circuit to provide shielding from gamma radiation. Some of the fuel is then removed and replaced with fresh fuel rods, whilst other fuel rods may be repositioned within the reactor pressure vessel. The spent fuel is typically lifted by remote handing techniques. Typically, in the fuel route a fuel rod or assembly 16 is lifted out of the reactor pressure vessel using an overhead travelling crane 14. Once above the reactor pressure vessel it is translated horizontally using the overhead travelling crane and deposited in a turnover rig 15 which rotates the spent fuel rod into the horizontal position. The turnover rig moves the fuel out of containment via a flooded tunnel.

One type of PWR reactor, is a so called close coupled PWR in which the reactor pressure vessel and the steam generators are connected by shot sections of pipe without any structure in between. This arrangement makes conventional refuelling methods to be either impossible or much more complex and difficult. Alternatively, they can affect the design considerations for the plant, in particular it can add limitations to the degree to which the plant may be close coupled. As such there is a need for an alternative method and configuration to enable refuelling of the reactor.

### SUMMARY OF THE DISCLOSURE

According to a first aspect there is provided a lift head for a reactor pressure vessel comprising: a lift head which can be coupled and removed to a reactor pressure vessel head, and radiation shielding, wherein the radiation shielding is connectable to the lift head such that the lift head and the radiation shield encase the reactor pressure vessel head and any head package contents removed from a reactor pressure vessel with the reactor pressure vessel head.

The radiation shield may be of a dam shell construction.

The lift head my be provided with a mechanism for fastening and unfastening the bolts connecting the reactor pressure vessel head to the reactor pressure vessel.

The lift head may be provided with closable portals through which access may be gained.

The lift head may be provided with monitoring equipment to monitor the core internals.

The lift head may be provided with a drip tray.

The lift head may be provided with a dehumidifier.

The lift head may be provided with a seal and a negative pressure system to contain any irradiated components.

According to a second aspect of the invention there is provided a lift system for the reactor pressure vessel head of a nuclear reactor comprising: a crane comprising a support and a winch system extendible from a retracted position to a lowered position; and wherein the crane is coupled to a lift head according to the first aspect as discussed above.

The second radiation shield may be provided for shielding any removed core internals separate from the reactor pressure vessel.

The second shield may be a clam shell shield.

The lift system may be mounted in a space above the containment structure, and a hatch is provided to access the containment.

The shield may be connected to the lift head when the reactor pressure vessel head has been lifted into the space above the containment.

The track may be provided to move the lift head and the shield away from the hatch.

According to a third aspect of the invention there is provided a lift system for the reactor pressure vessel head of a nuclear reactor comprising: a hydraulic jack, which is coupled to a lift head according to any one of claims 1 to 8.

Optional features of aspects will now be set out. These are applicable singly or in any combination.

The present invention may comprise or be comprised as part of a nuclear reactor power plant (referred to herein as a nuclear reactor). In particular, the present invention may relate to a Pressurized Water Reactor. Alternatively, it may relate to a Boiling Water Reactor. The nuclear reactor power plant may have a power output between 250 and 600 MW or between 300 and 550 MW.

The nuclear reactor power plant may be a modular reactor. A modular reactor may be considered as a reactor comprised of a number of modules that are manufactured off site (e.g. in a factory) and then the modules are assembled into a nuclear reactor power plant on site by connecting the modules together. Any of the primary, secondary and/or tertiary circuits may be formed in a modular construction.

The nuclear reactor of the present disclosure may comprise a primary circuit comprising a reactor pressure vessel; one or more steam generators, Furthermore, it may compromise one or more pressurizer. The primary circuit circulates a medium (e.g. water) through the reactor pressure vessel to extract heat generated by nuclear fission in the core, the heat is then delivered to the steam generators and transferred to the secondary circuit. The primary circuit may comprise between one and six steam generators; or between two and four steam generators; or may comprise three steam generators; or a range of any of the aforesaid numerical values. The primary circuit may comprise one; two; or more than two pressurizers.

The primary circuit may comprise a circuit extending from the reactor pressure vessel to each of the steam generators, the circuits may carry hot medium to the steam generator from the reactor pressure vessel, and carry cooled medium from the steam generators back to the reactor pressure vessel. The medium may be circulated by one or more pumps. In some embodiments, the primary circuit may comprise one or two pumps per steam generator in the primary circuit.

In some embodiments, the medium circulated in the primary circuit may comprise water. In some embodiments, the medium may comprise a neutron absorbing substance added to the medium (e.g., boron, gadolinium). In some embodiments the pressure in the primary circuit may be at least 50, 80 100 or 150 bar during full power operations, and pressure may reach 80, 100, 150 or 180 bar during full power operations. In some embodiments, where water is the medium of the primary circuit, the heated water temperature of water leaving the reactor pressure vessel may be between 540 and 670 K, or between 560 and 650 K, or between 580 and 630 K during full power operations. In some embodiments, where water is the medium of the primary circuit, the cooled water temperature of water returning to the reactor pressure vessel may be between 510 and 600 K, or between 530 and 580 K during full power operations.

The nuclear reactor of the present disclosure may comprise a secondary circuit comprising circulating loops of water which extract heat from the primary circuit in the steam generators to convert water to steam to drive turbines. In embodiments, the secondary loop may comprise one or two high pressure turbines and one or two low pressure turbines.

The secondary circuit may comprise a heat exchanger to condense steam to water as it is returned to the steam generator. The heat exchanger may be connected to a tertiary loop which may comprise a large body of water to act as a heat sink.

The reactor vessel may comprise a steel pressure vessel, the pressure vessel may be from 5 to 15 m high, or from 9.5 to 11.5 m high and the diameter may be between 2 and 7 m, or between 3 and 6 m, or between 4 to 5 m. The pressure vessel may comprise a reactor body and a reactor head positioned vertically above the reactor body. The reactor head may be connected to the reactor body by a series of studs that pass through a flange on the reactor head and a corresponding flange on the reactor body.

The reactor head may comprise an integrated head assembly in which a number of elements of the reactor structure may be consolidated into a single element. Included among the consolidated elements are a pressure vessel head, a cooling shroud, control rod drive mechanisms, a missile shield.

The nuclear core may be comprised of a number of fuel assemblies, with the fuel assemblies containing fuel rods. The fuel rods may be formed of pellets of fissile material. The fuel assemblies may also include space for control rods. For example, the fuel assembly may provide a housing for a 17×17 grid of rods i.e. 289 total spaces. Of these 289 total spaces, 24 may be reserved for the control rods for the reactor, each of which may be formed of 24 control rodlets connected to a main arm, and one may be reserved for an instrumentation tube. The control rods are movable in and out of the core to provide control of the fission process undergone by the fuel, by absorbing neutrons released during nuclear fission. The reactor core may comprise between 100-300 fuel assemblies. Fully inserting the control rods may typically lead to a subcritical state in which the reactor is shutdown. Up to 100% of fuel assemblies in the reactor core may contain control rods.

Movement of the control rod may be moved by a control rod drive mechanism. The control rod drive mechanism may command and power actuators to lower and raise the control rods in and out of the fuel assembly, and to hold the position of the control rods relative to the core. The control rod drive mechanism rods may be able to rapidly insert the control rods to quickly shut down (i.e. scram) the reactor.

The primary circuit may be housed within a containment structure to retain steam from the primary circuit in the event of an accident. The containment may be between 15 and 60 m in diameter, or between 30 and 50 m in diameter. The containment structure may be formed from steel or concrete, or concrete lined with steel. The containment may contain within or support exterior to a water tank for emergency cooling of the reactor. The containment may contain equipment and facilities to allow for refuelling of the reactor, for the storage of fuel assemblies and transportation of fuel assemblies between the inside and outside of the containment.

The power plant may contain one or more civil structures to protect reactor elements from external hazards (e.g. missile strike) and natural hazards (e.g. tsunami). The civil structures may be made from steel, or concrete, or a combination of both.

### BRIEF DISCUSSION OF THE FIGURES

Embodiments of the invention will now be described by way of example with reference to the accompanying drawings in which:

FIG. 1 is a schematic diagram of a prior art refuelling method;

FIG. 2 is a schematic diagram of a PWR;

FIG. 3 shows a schematic of the removal of the reactor head

and FIG. 4 shows a cross section of a sealed reactor pressure vessel within a containment structure.

### DETAILED DESCRIPTION

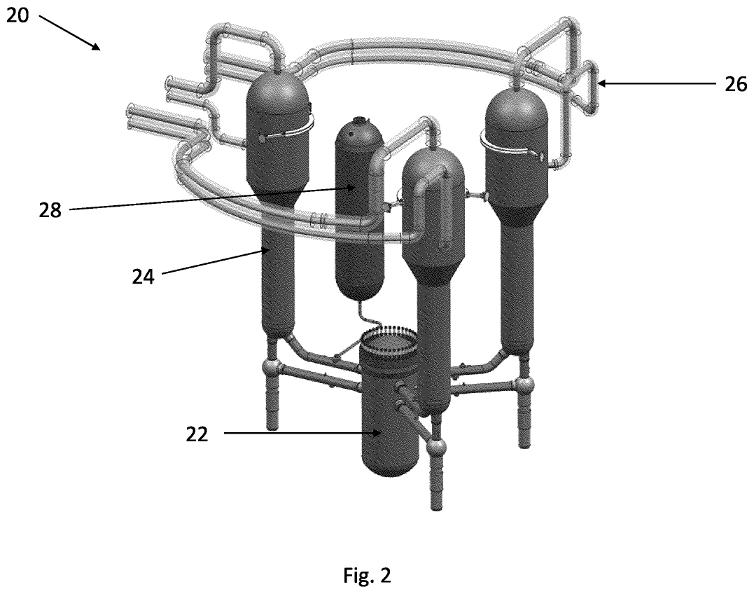

FIG. 2 is a schematic diagram of a PWR 20. An RPV 22 containing fuel assemblies is centrally located in the reactor. Clustered around the RPV are three steam generators 24 connected to the RPV by pipework 26 of the pressurised water, primary coolant circuit. Coolant pumps circulate pressurised water around the primary coolant circuit, taking heated water from the RPV to the steam generators, and cooled water from the steam generators to the RPV.

A pressuriser 28 maintains the water pressure in the primary coolant circuit at about 155 bar.

In the steam generators 24, heat is transferred from the pressurised water to feed water circulating in pipework 26 of a secondary coolant circuit, thereby producing steam which is used to drive turbines which in turn drive an electricity-generator. The steam is then condensed before returning to the steam generators.

The reactor core is maintained within the containment and is surrounded by a plurality of steam generators. The steam generators may be in a close-coupled configuration with the reactor pressure vessel resulting in there being no physical barriers between the steam generators and the reactor pressure vessel, this for example is the configuration used in some reactors, such as the Russian VBER 300. In this type of reactor the reactor pressure vessel and the steam generators are connected by shot sections of pipe without any structure in between. The use of a close coupled plant has a number of advantages over a conventional dispersed design. The main benefit however is the ability of the primary circuit to be reduced in diameter, which consequently, reduces the size of the power station as a whole. This reduction in size of the power station may enable a change in the design and manufacturing techniques used for constructing the containment building. Consequently, these reactors have the potential to be used in small modular reactors (SMR). However, such configurations can result in lack of access space for the refuelling system to be positioned.

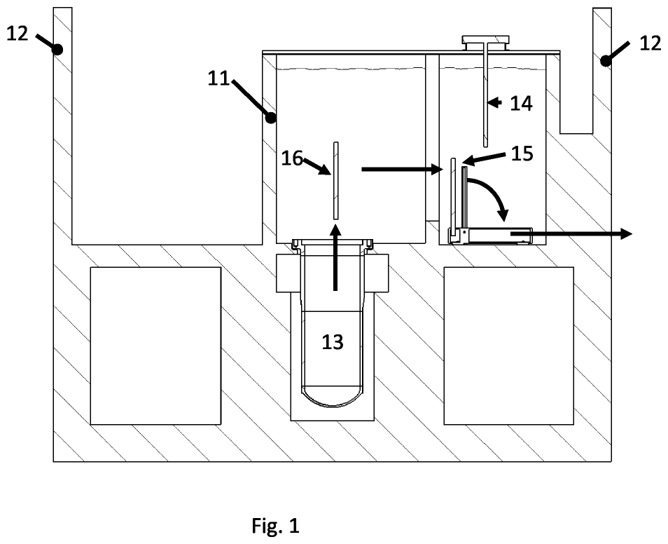

The close coupled reactor, however, due to its more compact geometry does not allow for the use of the refuelling equipment shown in FIG. 1. In particular, the limitation in space makes the operation of the lift crane for moving the reactor pressure vessel head more difficult. Consequently, a means of overcoming this limited space is through the use of a crane and a shield structure for the reactor pressure vessel head and any connected core internals. The crane may be located either at the top of or in a space above the containment structure and is used to lift the reactor pressure vessel head away from the reactor pressure vessel. The crane may be mobile, and either be mounted on rails on the floor or may be mounted to a gantry on the ceiling. Alternatively, the crane may be statically positioned to the ceiling in a space above the containment structure. The crane is positioned so that the crane hoist is able to be positioned vertically above the reactor core. Rather than using a crane, the head may be lifted using hydraulic jacks. Access to the containment structure, if the crane is located in a space above, may be provided through the use of a hatch. This hatch will be capable of being opened and closed for the process of operating the pressure vessel head lift crane. The hatch may be automatically or manually opened. The hatch in the containment must be large enough to allow access for the crane and to be able to accommodate the removal of the reactor pressure vessel head from the containment structure. The crane arm can be lowered through the hatch and to a position proximate to the head. The head may be provided with an integrated bolt tightening system, which allows the head to be released remotely. In this case the head is lowed into position to allow this process to happen. Once the bolts have been removed either using a feature on the head or by any other suitable means the crane is then attached to the reactor pressure vessel head. The connection may occur at a single point or may be coupled to more than one position on the reactor pressure vessel head. With the crane securely connected to the reactor pressure vessel head it can be lifted out of its position at the top of the reactor. Once it is above the level of the reactor the crane may move in a translation movement such that the head may be moved to a location away from the reactor for safety. The reactor head may also comprise the core internals, which may also be removed with the reactor head.

Whilst the reactor head is in the space above the reactor pressure vessel and safely distant form the steam generators, this may either be inside or outside of the containment structure, a shield is placed around the reactor head. The shield may be a clam-shell shield; this will allow for it to be closed and the reactor pressure vessel head lowered into it. The shield may be designed such that a shine path would not be presented, whilst the head is lifted into the shield. This may be done through the use of overlapping elements. The shield may incorporate access to internals such that monitoring, or inspection equipment can be used. Alternatively, the shield may be provided with monitoring or inspection equipment to monitor the condition of any core internals removed with the reactor pressure vessel head that are contained within the shield. The shield may incorporate a drip tray to catch any residual water still present on the head or the core internals after they have been removed. The shield may have a dehumidifier or similar desiccator to remove any residual water from the head or the core internals after the head has been removed. The shield may include a seal and negative pressure system to contain the irradiated components. The lift may be accomplished remotely. This will mean that radiation shielding for the core internals during the removal process would not be required.

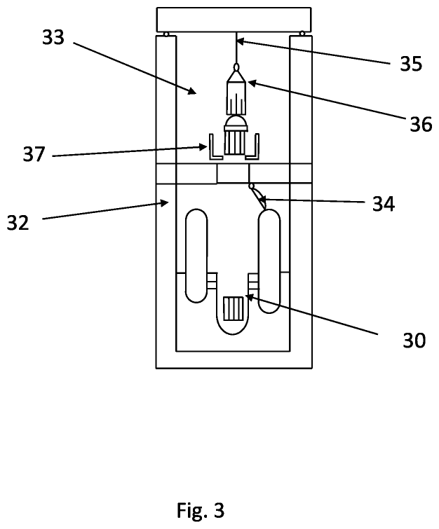

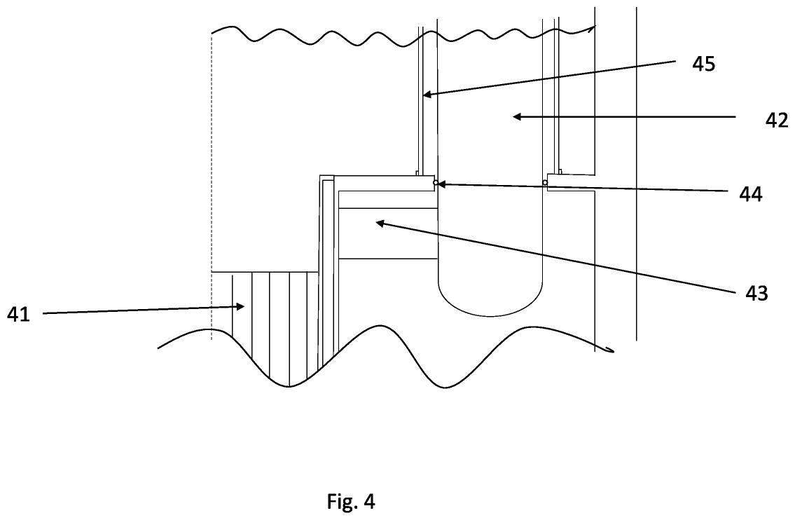

An embodiment of this is shown in FIG. 3, which shows the removal of the reactor pressure vessel head. The reactor pressure vessel 30 with steam generators 31 is located in a containment structure 32. The containment structure has a space 33 above the reactor which is accessible through a hatch 34. The hatch may either open into the containment or into the space above the containment. A crane 35 in this case is mounted to the roof of the space above the containment structure. The crane comprises a support mounted to the containment or to other suitable structure. The crane has a winch which when not in use rest in a retracted state in a retracted position and when in use is extended to a lowered position. In the lowered position A coupling mechanism is provided for coupling the winch to the reactor pressure vessel head. Using this the crane is used to lift the reactor pressure vessel head 36 and any associated core internals away from the reactor and into the space above the containment structure where they are then covered by a protective shield 37. When the refuelling is complete the reactor pressure vessel head and any associated core internals is then lowered using the crane back into position on to the top of the reactor pressure vessel. From there if present the bolting mechanism can be used to tighten the bolts and reconnect the reactor pressure vessel head. The shield may be located on rails. These rails may be used to transport the head away from the hatch into containment and to a storage location.

The containment may be flooded, and the head may be lifted vertically using the crane until the reactor flange is at water level. Prior to lifting or removing the head a shield is placed either side of the head flange. By lifting the head within the water in the flooded containment the shield device may be slid under the head and the head can then be lowered into the shield. Once it is in the shield may be sealed. With the shield in position the head can be moved to a support device such as a rai track that can transport the head to a storage area. The head may then be lowered onto the transport and the winch disconnected.

FIG. 4 presents an illustrative example of the flooding of the containment structure—in this figure only half of the containment structure is displayed. The core is contained in a reactor pressure vessel 41 and is connected to a steam generator 42 via a pipeline 43. The entire containment is flooded prior to the removal of the fuel from the reactor core. In this example a seal 44 is provided to prevent flooding of the containment below the reactor flange. The steam generators, pressurisers or other associated equipment may not need to be immersed in the flooding in the containment. In this case a barrier 45 may be positioned around these features to protect them from the water. The barrier in such a case would extend from the level of the reactor flange to above the flooding water level. Passageways may be created using the barrier to allow personal and equipment to be moved between the spaces above and below the refuelling pool may be included. The barrier may be cylindrical and extend above the water level enclosing and connected to the reactor head, such that it is lifted with the head. The benefit of such a configuration is that it does not require the water level in the reactor to be lowered prior to the flood of the containment.

The use of such a method has advantages over alternative methods such as the use of a refuelling cavity, trunking or the use of a refuelling machine. In comparison with a refuelling cavity the above described method removes the need for such a cavity; thus removing structural complexity from the design as the containment wall provides the structure to hold the refuelling water. Also, the removal of the walls around the reactor pressure vessel and steam generators allow the system to be closely coupled, which reduces the size of the reactor. In comparison with trunking the method reduces the amount water height required above the reactor, which in turn simplifies the construction of the containment. In comparison with a refuelling machine the method allows for a simplification of the machine as pool water acts as a radiation shield, so this reduces the need for the refuelling machine to be able to shield and move the fuel at the same time.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A lift head system for a nuclear reactor pressure vessel comprising:
a lift head which can be coupled and removed to a reactor pressure vessel head of the nuclear reactor pressure vessel, and radiation shielding, wherein:
the radiation shielding is connectable to the lift head such that the lift head and the radiation shielding encase the reactor pressure vessel head when removed from the nuclear reactor pressure vessel and encase any head package contents removed from the nuclear reactor pressure vessel with the reactor pressure vessel head.

2. The lift head system for a nuclear reactor pressure vessel according to claim 1, wherein the radiation shield is of a clam shell construction.

3. The lift head system for a nuclear reactor pressure vessel according to claim 1, wherein the lift head is provided with a mechanism for fastening and unfastening the bolts connecting the reactor pressure vessel head to the reactor pressure vessel.

4. The lift head system for a nuclear reactor pressure vessel according to claim 1, wherein the lift head system is provided with closable portals through which access may be gained.

5. The lift head system for a nuclear reactor pressure vessel according to claim 1, wherein the lift head system is provided with monitoring equipment to monitor the core internals.

6. The lift head system for a nuclear reactor pressure vessel according to claim 1, wherein the lift head system is provided with a drip tray.

7. The lift head system according to claim 1, wherein the lift head system is provided with a dehumidifier.

8. The lift head system for a nuclear reactor pressure vessel according to claim 1, wherein the lift head system is provided with a seal and a negative pressure system to contain any irradiated components.

9. A lift system for a reactor pressure vessel head of a nuclear reactor comprising:
the lift head system according to claim 1; and
a crane comprising a support and a winch system extendible from a retracted position to a lowered position; wherein the crane is coupled to the lift head system.

10. The lift system for the reactor pressure vessel head according to claim 9, wherein the lift system further comprises a second radiation shield for shielding any removed core internals separate from the nuclear reactor pressure vessel.

11. The lift system for the reactor pressure vessel head according to claim 10, wherein the second shield is a clam shell shield.

12. A nuclear reactor power plant comprising:
a containment structure containing a nuclear reactor pressure vessel;
the lift head system according to claim 1 mounted in a space above the containment structure; and
wherein a hatch is provided to access the containment structure.

13. A nuclear reactor power plant comprising:
a containment structure containing a nuclear reactor pressure vessel;
the lift system according to claim 10; and;
wherein the second radiation shield is connected to the lift head when the reactor pressure vessel head has been lifted into the space above the containment structure.

14. The nuclear reactor power plant according to claim 12, wherein a track is provided to move the lift head and the shield away from the hatch.

15. A lift system for the reactor pressure vessel head of a nuclear reactor comprising:
the lift head system according to claim 1, and
a hydraulic jack, which is coupled to the lift head system.

16. The lift system for the reactor pressure vessel head according to claim 9, wherein the crane is mounted on rails on a floor, or a gantry on a ceiling such as to be mobile.
